(19) United States
(12) Patent Application Publication
(10) Pub. No.: US 2024/0421916 A1
(43) Pub. Date: Dec. 19, 2024

(54) OUT-OF-BAND SIGNALING FOR LOCATION-BASED USER DEVICE TRIGGERS

(71) Applicant: T-MOBILE INNOVATIONS LLC, Overland Park, KS (US)

(72) Inventors: Peter Philip MYRON, New Braunfels, TX (US); Michael John MITCHELL, North Bend, WA (US)

(21) Appl. No.: 18/334,908

(22) Filed: Jun. 14, 2023

(51) Int. Cl. H04B 11/00

(52) U.S. Cl. CPC H04B 11/00

(57) ABSTRACT

The technologies discussed herein relate to methods, systems, media, etc., for transmitting out-of-band signals to initiate a user device trigger. In embodiments, an out-of-band node is configured to wirelessly transmit out-of-band signals to a user device that is within a threshold distance of the out-of-band node. For example, an out-of-band signal can include an ultrasonic wave. In some embodiments, two or more out-of-band nodes are positioned in an indoor room of a building. In embodiments, the transmitted out-of-band signals transmitted by the out-of-band node can include encoded data, which was received by the out-of-band node over a network from one or more servers, wherein the encoded data, when received by a user device via the out-of-band signal, triggers the user device to initiate an action. For example, the action may include automatically opening an application and initiating an update to a telecommunications service.

### SUMMARY

A high-level overview of various aspects of the technology disclosed herein is provided here for that reason, to provide an overview of the disclosure and to introduce a selection of concepts that are further described in the Detailed Description section below. This Summary is not intended to identify key features or essential features of the claimed subject matter, nor is it intended to be used as an aid in isolation to determine the scope of the claimed subject matter. The present disclosure is directed, in part, to systems and methods corresponding to out-of-band signaling for location-based user device triggers, substantially as shown in and/or described in connection with at least one of the figures, and as set forth more completely in the claims.

In aspects set forth herein, and at a high level, the systems, methods, and media disclosed herein correspond to initiating a user device trigger for a user device action based on the user device receiving, from an out-of-band node, an out-of-band signal that includes encoded data. For example, the out-of-band node may be an ultrasonic transmitter that transmits high frequency sound waves at a particular frequency, voltage, beam angle, and transmission pattern. In some embodiments, two or more out-of-band nodes may be positioned at particular locations within an indoor room of a building (e.g., a store) or at particular locations throughout an outdoor venue (e.g., a sporting venue, a concert venue, an art fair). For example, each of the out-of-band nodes within a particular location may be within a threshold distance of at least one other out-of-band node. In some embodiments, a first out-of-band node can transmit out-of-band signals having a first high frequency sound wave and a second out-of-band node can transmit out-of-band signals having a second high frequency sound wave, wherein the first high frequency sound wave has a different frequency than the second high frequency sound wave. In some embodiments, the out-of-band signals transmitted by the first out-of-band node includes a first set of encoded data and the out-of-band signals transmitted by the second out-of-band node includes a second set of encoded data, wherein the first set of encoded data triggers a different user device action than the second set of encoded data.

In embodiments, one or more servers can generate one or more sets of encoded data for triggering a user device action. For example, the one or more servers can provide the one or more sets of encoded data to one or more out-of-band nodes. As such, an out-of-band node can transmit out-of-band signals to a user device located within a threshold distance from the out-of-band node, the out-of-band signals including at least one set of encoded data that triggers an action by the user device upon receiving the out-of-band signal. In some embodiments, the action involves launching a particular application or webpage. In some embodiments, the action involves automatically providing, via a display of the user device, a notification or warning (e.g., an emergency notification or warning based on the user device's proximity to the out-of-band node, a notification of a purchasable offer, a notification of a discount). In some embodiments, the user device action involves emitting light from a light component of the user device or emitting sound (e.g., at a frequency between 20 Hz and 20,000 Hz) from a sound emitting component of the user device.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached figures, which are intended to be exemplary and non-limiting, wherein:

FIG. 1 depicts an example environment corresponding to the out-of-band signaling for location-based user device triggers, in accordance with embodiments herein;

FIG. 2 illustrates an example operational environment for the user device, out-of-band node, and corresponding server, in accordance with embodiments herein;

FIG. 3 depicts a flow diagram of an example user device method corresponding to the out-of-band signaling for location-based user device triggers, in accordance with aspects herein;

FIG. 4 depicts another flow diagram of an example out-of-band node method for the out-of-band signaling for location-based user device triggers, in accordance with aspects herein;

FIG. 5 depicts another flow diagram of an example server method for the out-of-band signaling for location-based user device triggers, in accordance with aspects herein; and

FIG. 6 depicts an example user device suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Cellular Communication System
4G Fourth-Generation Cellular Communication System
5G Fifth-Generation Cellular Communication System
6G Sixth-Generation Cellular Communication System
AOA Angle of Arrival
API Application Programming Interface
CA Carrier Aggregation
CD-ROM Compact Disk Read Only Memory
CDMA Code Division Multiple Access
DVD Digital Versatile Discs
EEPROM Electrically Erasable Programmable Read Only Memory
EMF Electromagnetic Field
EMS Enhanced Messaging Service
eNB Evolved Node B
Ev-DO Evolution-Data Optimized
FD-MIMO Full-Dimension Multiple-Input Multiple-Output
gNB Next Generation Node B
GPRS General Packet Radio Service
GSM Global System for Mobile communications
HSS Home Subscriber System
IEEE Institute of Electrical and Electronics Engineers
IP Internet Protocol
LTE Long Term Evolution
MAC Media Access Control
MIMO Multiple-Input Multiple-Output
MME Mobility Management Entity
MMS Multimedia Messaging Service
MU-MIMO Multi-User Multiple-Input Multiple-Output
NR New Radio
OTDOA Observed Time Difference of Arrival
PC Personal Computer
PDA Personal Digital Assistant
RAM Random Access Memory
RAN Radio Access Node
RF Radio-Frequency
ROM Read Only Memory
RRC Radio Resource Control
RRU Remote Radio Unit
RSRP Reference Signal Received Power
RSRQ Reference Signal Received Quality
RSSI Received Signal Strength Indicator
RTT Round-Trip Time
SMS Short Message Service
TCP Transmission Control Protocol
TDMA Time Division Multiple Access
TOA Time of Arrival
UDP User Datagram Protocol
UE User Equipment
VONR Voice over NR
VOLTE Voice over LTE
WiMAX Worldwide Interoperability for Microwave Access

In addition, words such as “a” and “an,” unless otherwise indicated to the contrary, may also include the plural as well as the singular. Thus, for example, the constraint of “a feature” is satisfied where one or more features are present. As such, an element in the singular may refer to “one or more.”

Further, the term “or” includes the conjunctive, the disjunctive, and both (a or b thus includes either a or b, as well as a and b).

In addition, the term “some” may refer to “one or more.”

The term “combination” (e.g., one or more combinations thereof) may refer to, for example, “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

The term “communicating” (e.g., the user device communicating, a server communicating) may refer to, for example, receiving or transmitting a signal, data, a message, another type of communication, or one or more combinations thereof.

Unless specifically stated otherwise, descriptors such as “first,” “second,” and “third,” for example, are used herein without imputing or otherwise indicating any meaning of priority, physical order, arrangement in a list, or ordering in any way, but are merely used as labels to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

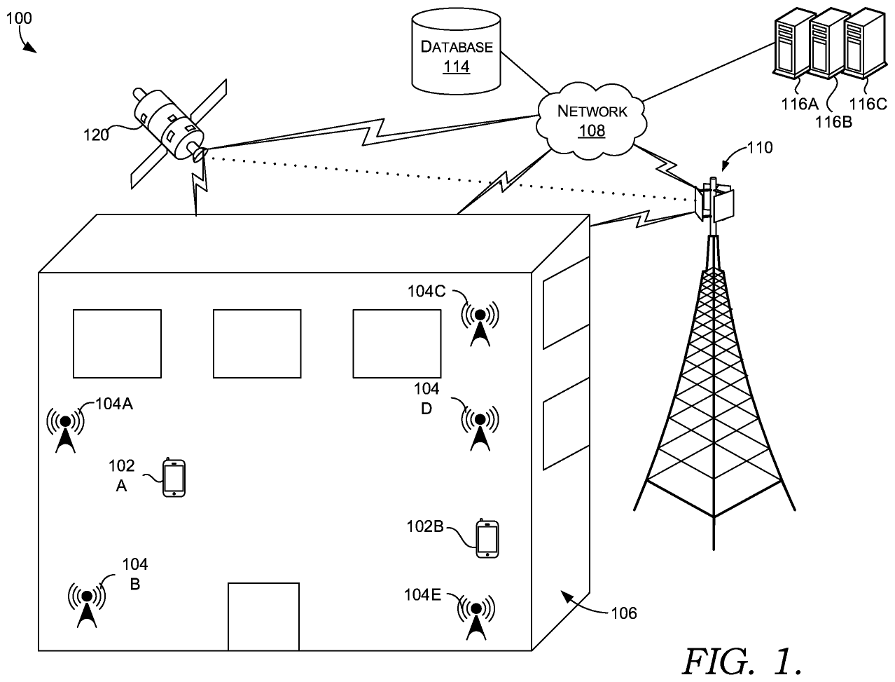

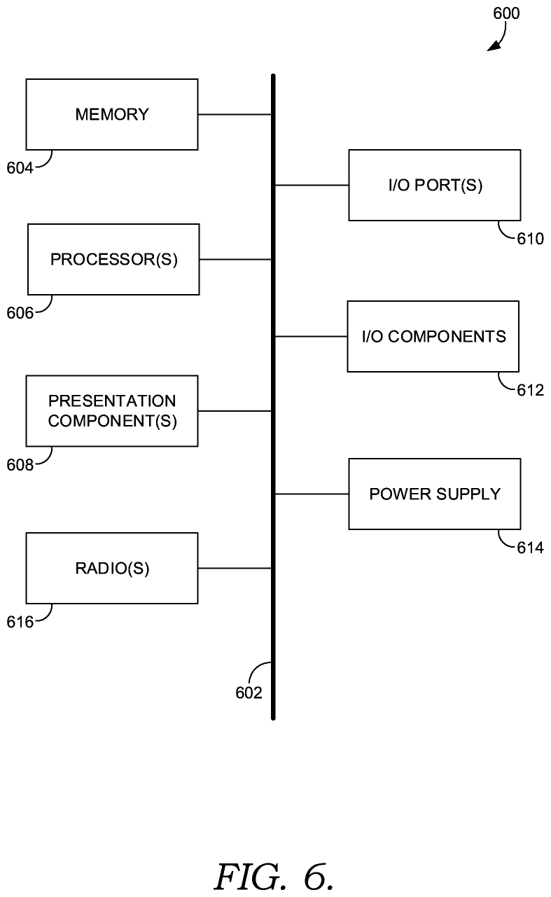

Additionally, “user device,” as used herein, is a device that has the capability of using a wireless telecommunications network, and may also be referred to as a “computing device,” “mobile device,” “user equipment” (UE), or “wireless communication device.” A user device, in some aspects, may take on a variety of forms, such as a PC, a laptop computer, a tablet, a mobile phone, a PDA, a server, an Internet of Things device, any other device capable of communicating with other devices (e.g., by transmitting or receiving a signal) using a wireless communication, or one or more combinations thereof. A user device may be, in an embodiment, similar to user devices 102A-102B described herein with respect to FIG. 1. A user device may also be, in another embodiment, similar to user device 600, described herein with respect to FIG. 6.

As noted above, the user device may include Internet of Things devices, such as one or more of the following: a sensor (e.g., a temperature sensor), controller (e.g., a lighting controller, a thermostat), an appliance (e.g., a smart refrigerator, a smart air conditioner, a smart alarm system), other Internet of Things devices, or one or more combinations thereof. Internet of Things devices may be stationary, mobile, or both. In some aspects, the user device is associated with a vehicle (e.g., a video system in a car capable of receiving media content stored by a media device in a house when coupled to the media device via a local area network). In some aspects, the user device comprises a medical device, a location monitor, a clock, a drone, a remote weather station, another wireless communication device, or one or more combinations thereof.

In embodiments, a user device discussed herein may be configured to communicate using one or more of 4G (e.g., LTE), 5G, 6G, another generation communication system, or a combination thereof. In some aspects, the UE has a radio that connects with a 4G cell site but is not capable of connecting with a higher generation communication system. In some aspects, the UE has components to establish a 5G connection with a 5G gNB, and to be served according to 5G over that connection. In some aspects, the user device may be an E-UTRAN New Radio-Dual Connectivity (ENDC) device. ENDC allows a user device to connect to an LTE eNB that acts as a master node and a 5G gNB that acts as a secondary node. As such, in these embodiments, the ENDC device may access both LTE and 5G simultaneously, and in some cases, on the same spectrum band.

The term “out-of-band node” may refer to, for example, a device capable of transmitting out-of-band signals, such as one or more ultrasonic frequencies (e.g., 20 kHz or higher). Additionally or alternatively, an “out-of-band node” may refer to a device configured to transmit out-of-band signals at frequencies other than frequencies corresponding to 5G, 4G, etc. (e.g., frequencies other than 24-54 GHz, frequencies other than 600-900 MHz). Additionally or alternatively, an “out-of-band node” may refer to a device configured to transmit out-of-band signals at frequencies other than frequencies corresponding to Wi-Fi communications (e.g., frequencies other than 900 MHz, 2.4 GHz, 3.6 GHz, 4.9 GHz, 5 GHz, 5.9 GHz, 6 GHz and 60 GHz).

As used herein, the term “cell site” generally refers to one or more cellular base stations, nodes, RRUs control components, other components configured to provide a wireless interface between a wired network and a wirelessly connected user device, or a combination thereof. A cell site may comprise one or more nodes (e.g., eNB, gNB, other nodes, or one or more combinations thereof) that are configured to communicate with user devices. In some aspects, the cell site may include one or more band pass filters, radios, antenna arrays, power amplifiers, transmitters/receivers, digital signal processors, control electronics, GPS equipment, other equipment, or a combination thereof. A cell site or a node (e.g., eNB or gNB) corresponding to the cell site may comprise one or more of a macro base station, a small cell or femtocell base station, a relay base station, another type of base station, or one or more combinations thereof. In aspects, the cell site may be configured as FD-MIMO, massive MIMO, MU-MIMO, cooperative MIMO, 3G, 4G, 5G, 6G, another generation communication system, or one or more combinations thereof. In addition, the cell site may operate in an extremely high frequency region of the spectrum (e.g., from 30 GHz to 300 GHz), also known as the millimeter band.

A “telecommunication service” may refer to a satellite communication service, a microwave communication service, a millimeter wave communication service, a voice service (e.g., VoIP, an audio conferencing service), a messaging service (e.g., SMS messages, MMS messages, instant messaging messages, an EMS service messages), a data service (e.g., an internet service, an emailing service, a file transferring service), a wireless service through a wireless network, a cloud-based service, a managed service operated by a particular provider (e.g., a managed network service, a managed security service, a managed hosting service), other types of telecommunication services, or one or more combinations thereof.

Embodiments of the technology described herein may be embodied as, among other things, a method, system, or computer-program product. Accordingly, the embodiments may take the form of a hardware embodiment, or an embodiment combining software and hardware. An embodiment that takes the form of a computer-program product can include computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, DVD, holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal (e.g., a modulated data signal referring to a propagated signal that has one or more of its characteristics set or changed to encode information in the signal). Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, prior relevant technologies have not identified user devices (e.g., a user device associated with a particular provider) using one or more out-of-band nodes. In addition, prior relevant technologies have not initiated automatic user device actions by using out-of-band nodes. For example, prior relevant technologies have required users of user devices to perform operations to the user device for those particular user device actions to occur (e.g., selecting an application icon to open an application). Furthermore, prior relevant technologies have not utilized out-of-band nodes for communications with user devices or services, wherein the communications automatically initiate user device actions. In this way, the prior relevant technologies have had challenges that involve decreases in quality of service and user device experiences.

The technology discussed herein can alleviate the problems and shortcomings discussed above by increasing the quality of service and user device experience. In one embodiment, a system for transmitting out-of-band signals for a user device trigger is provided. For example, the system may comprise an out-of-band node configured to wirelessly transmit the out-of-band signals to a user device within a threshold distance of the out-of-band node and one or more processors corresponding to the out-of-band node. In some embodiments, the system also comprises a user device, a network, a base station or a satellite, and a server. The one or more processors of the out-of-band node are configured to perform operations comprising transmitting an out-of-band signal that includes encoded data for receipt by the user device within the threshold distance of the out-of-band node, wherein upon receipt by the user device, the encoded data triggers the user device to initiate an action. The operations also comprise receiving an indication that the user device has received the out-of-band signal and transmitting information associated with the user device receiving the out-of-band signal.

In some embodiments, the system further comprises a plurality of out-of-band nodes including the out-of-band node, each of the plurality of out-of-band nodes being within a second threshold distance from at least one other out-of-band node of the plurality of out-of-band nodes, wherein each of the plurality of out-of-band nodes are configured to wirelessly transmit one or more out-of-band signals, each out-of-band signal including encoded data to trigger an action by the user device upon receipt of the out-of-band signal by the user device. Additionally, in some embodiments, the out-of-band nodes can transmit information (e.g., a distance between the respective out-of-band node and the user device upon at the time the user device received the out-of-band signal, a distance between the respective out-of-band node and the user device based on a communication received by the user device, a version identifier of a software program downloaded on the user device, a user device identifier) to a server or another network device over a network based on the user device receiving the transmitted out-of-band signal.

In another embodiment, a method is provided for triggering an action by a user device. For example, the method may comprise generating one or more sets of encoded data that trigger a user device action and transmitting the one or more sets of encoded data to one or more out-of-band nodes. The method may also comprise generating a first set of operational instructions to transmit to one or more user devices, the first set of operational instructions to be transmitted based on the one or more user devices receiving an out-of-band signal from an out-of-band node, the out-of-band signal having a first set of encoded data that triggers a user device to initiate a first action. The method may also comprise receiving, over a network from a first user device, an indication that the first user device has received the out-of-band signal having the first set of encoded data. The method may also comprise providing the first user device, over the network, the first set of operational instructions. For example, the first set of operational instructions may cause the first user device to display a notification or alert based on the first user device receiving the out-of-band signal (e.g., based on the user device's location).

Another embodiment may comprise one or more non-transitory computer storage media having computer-executable instructions embodied thereon, that when executed by at least one processor, cause the at least one processor to perform a method for initiating a user device trigger based on receiving out-of-band signals. For example, the method may comprise receiving, via a user device, an out-of-band signal from an out-of-band node, the out-of-band signal including encoded data that triggers an action via the user device upon receipt by the user device, wherein the user device is within a threshold distance of the out-of-band node. The method may also comprise triggering, via the user device, the action based on the encoded data without utilizing a telecommunication service provided by a telecommunication service provider. The method may also comprise receiving, via the user device, information over a network based on triggering the action.

Turning now to FIG. 1, example environment 100 comprises user devices 102A-102B, out-of-band nodes 104A-104E, building 106, network 108, cell site 110, database 114, servers 116A-116C, and satellite 120. Example environment 100 is but one example of a suitable environment for out-of-band signaling for location-based user device triggers, and is not intended to suggest any limitation as to the scope of use or functionality of the invention. Neither should the environment 100 be interpreted as having any dependency or requirement relating to any one or combination of components illustrated. As an example, another embodiment of example environment 100 may include more or less user devices, out-of-band nodes, networks, cell sites, databases, servers, or satellites. As another example, another embodiment of example environment 100 may include drone user devices, drone satellites, airplane satellites, other network components, other types of devices capable of communicating via network 108, or one or more combinations thereof. In yet another example, although building 106 is illustrated as an indoor environment, in other implementations, the out-of-band nodes 104A-104E may be positioned throughout an outdoor environment.

In embodiments, one or more of the user devices 102A-102B may include one or more of a unit, a station, a terminal, a client, etc., or one or more combinations thereof. One or more of the user devices 102A-102B may, in some embodiments, include a wireless local loop station, an IoT device, an Internet of Everything device, a machine type communication device, an evolved or enhanced machine type communication device, another type of user device, or one or more combinations thereof. The user devices 102A-102B (e.g., the machine type communication device or the evolved or enhanced machine type communication device) may include, for example, one or more robots, drones, remote devices, sensors (e.g., an out-of-band signal sensor), meters, monitors, location tags, etc., that may communicate with cell site 110, another device (e.g., the out-of-band nodes 104A-104E), or some other entity (e.g., the servers 116A-116C). In some embodiments, one or more of the user devices 102A-102B may be implemented in various objects such as appliances, vehicles, meters, or other objects. In some embodiments, one or more of the user devices 102A-102B may, at one time or another, act as a relay, base station, (e.g., an unmanned aerial vehicle acting as an aerial base station), or other network components (e.g., macro eNBs or gNBs, small cell eNBs or gNBs, or relay base stations). As such, in some embodiments, one or more signals transmitted from the unit, station, terminal, client, wireless local loop station, IoT device, Internet of Everything device, machine type communication device, evolved or enhanced machine type communication device, user device implemented in an object, another type of user device, or one or more combinations thereof, can be received by one or more of the cell site 110, the satellite 120, the servers 116A-116C, the out-of-band nodes 104A-104E, the database 114, another network component, or one or more combinations thereof.

As depicted by example environment 100, user devices 102A-102B (as well as additional user devices) may wirelessly communicate via network 108. User devices 102A-102B can communicate using one or more wireless communication standards. For example, the user devices 102A-102B may be configured to communicate using a wireless networking (e.g., Wi-Fi) or one or more peer-to-peer wireless communication protocols (e.g., Bluetooth, Wi-Fi peer-to-peer, other peer-to-peer protocols, or one or more combinations thereof) in addition to at least one cellular communication protocol (e.g., GSM, UMTS (associated with WCDMA or TD-SCDMA air interfaces, for example), LTE, LTE-A, 5G NR, HSPA, 3GPP2 CDMA2000 (e.g., 1×RTT, 1×EV-DO, HRPD, eHRPD), other cellular communication protocols, or one or more combinations thereof). The user devices 102A-102B may additionally or alternatively communicate using one or more global navigational satellite systems (GNSS, such as GPS or GLONASS for example), one or more mobile television broadcasting standards (e.g., ATSC-M/H or DVB-H), another wireless communication protocol, or one or more combinations thereof. In some embodiments, the user devices 102A-102B may include separate transmit or receive chains (e.g., including separate antennas and other radio components) for each wireless communication protocol with which it is configured to communicate.

The user devices 102A-102C can also communicate with the out-of-band nodes 104A-104E (e.g., via the network 108, via one or more out-of-band signals). In some embodiments, in addition to transmitting one or more types of out-of-band signals, the out-of-band nodes 104A-104E may also be configured to communicate to use a wireless networking (e.g., Wi-Fi), one or more peer-to-peer wireless communication protocols (e.g., Bluetooth, Wi-Fi peer-to-peer, other peer-to-peer protocols, or one or more combinations thereof), a cellular communication protocol (e.g., GSM, UMTS (associated with WCDMA or TD-SCDMA air interfaces, for example), LTE, LTE-A, 5G NR, HSPA, 3GPP2 CDMA2000 (e.g., 1×RTT, 1×EV-DO, HRPD, eHRPD), a global navigational satellite system (GNSS, such as GPS or GLONASS for example), a mobile television broadcasting standard (e.g., ATSC-M/H or DVB-H), another type of communication protocol, or one or more combinations thereof. In some embodiments, the out-of-band nodes 104A-104E may each have separate transmit or receive chains (e.g., separate antennas for transmitting out-of-band signals and other radio components).

In embodiments, one or more of the out-of-band nodes 104A-104E may include an ultrasound transmitter configured to transmit one or more frequencies of ultrasound signals for a particular duration within particular time intervals, which are detectable by the out-of-band sensors of the user devices 102A-102B. In some embodiments, the out-of-band nodes 104A-104E may transmit the out-of-band signals in a particular pattern. For instance, in some embodiments, a particular out-of-band sensor of the user device 102A is configured to detect a first pattern of the out-of-band transmission by the out-of-band node 104A, and the particular out-of-band sensor of the user device 102B is configured to detect a second pattern of the out-of-band transmission by the out-of-band node 104B, wherein the first pattern is different than the second pattern. For example, one or more of the servers 116A-116C may transmit operational instructions to the user device 102A to detect the first pattern and different operational instructions to the user device 102B to detect the second pattern.

In some embodiments, the out-of-band signals transmitted by the out-of-band nodes 104A-104E include small amounts of data payload (e.g., 20 bits to 144 bits, other ranges of low data payload) corresponding to encoded data for triggering a user device action. In some embodiments, one or more of the out-of-band nodes 104A-104E include a piezoelectric transducer (e.g., quartz or lead zirconate titanate used to generate an ultrasound wave via application of an electric field). In some embodiments, out-of-band node 104A includes a first piezoelectric transducer and out-of-band node 104B includes a second piezoelectric transducer, wherein the first piezoelectric transducer and the second piezoelectric transducer each have a crystal of a different dimensions, thicknesses, material, or one or more combinations thereof. In some embodiments, out-of-band node 104A includes a first capacitive transducer and out-of-band node 104B includes a second capacitive transducer, wherein the first capacitive transducer has conductive plates separated by a dielectric material that is a different material than the dielectric material of the and the second capacitive transducer. In some embodiments, one or more of the out-of-band nodes 104A-104E include a magnetostrictive transducer, an electrostatic transducer that generates high-frequency ultrasound, another type of transducer, or one or more combinations thereof. In some embodiments, one or more of the out-of-band nodes 104A-104E include a laser-based transducer or an air-coupled transducer having at least one piezoelectric element, at least one capacitive membrane, or one or more combinations thereof.

In embodiments, one or more of the out-of-band signals transmitted by one or more of the out-of-band nodes 104A-104E include a particular set of encoded data for receipt by the user device 102A or 102B upon receiving an out-of-band signal. In some embodiments, the first out-of-band node 104A transmits a first out-of-band signal having a first set of encoded data and the second out-of-band node 104B transmits a second out-of-band signal having a second set of encoded data, wherein the first set of encoded data and the second set of encoded data trigger different user device actions. In some embodiments, the first out-of-band signal has a different frequency than the second out-of-band signal. In some embodiments, the first out-of-band signal is transmitted at a different periodicity than the second out-of-band signal. In some embodiments, the first out-of-band signal is transmitted at a higher transmission power than the second out-of-band signal. In some embodiments, each of the sets of encoded data are transmitted by one or more of the servers 116A-116C over the network 108, such that the out-of-band nodes 104A-104E can include the set of encoded data within an out-of-band signal.

The network 108 may provide one or more telecommunication services via the cell site 110, the satellite 120, or one or more combinations thereof. In some embodiments, network 108 may provide one or more telecommunication services via the out-of-band nodes 104A-104E. The one or more telecommunication services may include, for example, the transfer of information without the use of an electrical conductor as the transferring medium. A wireless telecommunication service may correspond to the transfer of information via radio waves (e.g., Bluetooth®), satellite communication, infrared communication, microwave communication, Wi-Fi, millimeter wave communication, mobile communication, another type of communication, or a combination thereof. In embodiments, the telecommunication service may include one or more of a voice service, a message service (e.g., SMS messages, MMS messages, instant messaging messages, an EMS service messages), a data service, other types of wireless telecommunication services, or a combination thereof. In embodiments, the one or more telecommunication services may be provided by one or more communication providers. For example, user device 102A may correspond to a user who is registered or subscribed to a first telecommunication service provider to utilize one or more telecommunication services, and the user device 102B may correspond to a user registered or subscribed to a second telecommunication service provider that is different from the first telecommunication service provider. In some embodiments, one or more of the sets of encoded data are transmitted by one or more of the servers 116A-116C over the network 108 via a telecommunication service.

In some embodiments, the example operating environment 100 may support enhanced broadband communications, ultra-reliable (e.g., mission critical) communications, low latency communications, communications with low-cost and low-complexity devices, another type of communication, or one or more combinations thereof. In some embodiments, one or more communications between one or more devices in example operating environment 100 (e.g., communications between one or more of the user devices 102A-102B and one or more servers 116A-116C, communications between one or more servers 116A-116C and one or more out-of-band nodes 104A-104E) may correspond to the enhanced broadband communication, ultra-reliable communication, low latency communication, another type of communication, or one or more combinations thereof. As one example, one or more of the sets of encoded data may be transmitted by one or more of the servers 116A-116C over the network 108 via the enhanced broadband communication, ultra-reliable communication, low latency communication, another type of communication, or one or more combinations thereof. As another example, one or more of the servers 116A-116C may receive, over the network 108 (e.g., via the enhanced broadband communication, ultra-reliable communication, low latency communication, another type of communication, or one or more combinations thereof) from user device 102A or 102B, an indication that the first user device 102A has received the out-of-band signal having a first set of encoded data.

In embodiments, example environment 100 can utilize both licensed and unlicensed radio frequency bands. For example, the example environment 100 may employ License Assisted Access, LTE-Unlicensed radio access technology, or NR technology in an unlicensed band (e.g., 5 GHz industrial, scientific, and medical band). When operating in unlicensed radio frequency bands, cell site 110, one or more of servers 116A-116C, satellite 120, one or more of user devices 102A-102B, one or more of out-of-band nodes 104A-104E, another network component, or one or more combinations thereof, may employ carrier sensing for collision avoidance and detection. In some examples, operations in unlicensed bands may be based on a carrier aggregation configuration and component carriers operating in a licensed band. Operations in unlicensed spectrum may include downlink transmissions, uplink transmissions, P2P transmissions, D2D transmissions, another type of unlicensed spectrum operation, or one or more combinations thereof. As such, one or more communications-between or among two or more of cell site 110, one or more of servers 116A-116C, satellite 120, one or more of user devices 102A-102B, one or more of out-of-band nodes 104A-104E, another network component, or one or more combinations thereof—may correspond to a licensed or unlicensed radio frequency band, a 5 GHz industrial band, a 5 GHz scientific band, a 5 GHz medical band, a particular carrier aggregation configuration of a licensed band, a P2P transmission, a D2D transmission, another type of spectrum operation, or one or more combinations thereof. As one example, one or more of the servers 116A-116C may transmit the one or more of the sets of encoded data over the network 108 via the licensed or unlicensed radio frequency band, the 5 GHz industrial band, the 5 GHz scientific band, the 5 GHz medical band, the particular carrier aggregation configuration of a licensed band, the P2P transmission, the D2D transmission, another type of spectrum operation, or one or more combinations thereof. In yet another example, the one or more of the servers 116A-116C may transmit operational instructions (e.g., via the licensed or unlicensed radio frequency band, the 5 GHz industrial band, the 5 GHz scientific band, the 5 GHz medical band, the particular carrier aggregation configuration of a licensed band, the P2P transmission, the D2D transmission, another type of spectrum operation, or one or more combinations thereof) to user device 102A or 102B based on the user device action in response to the respective user device receiving the encoded data via the out-of-band signal.

In embodiments, the network 108 may correspond to one or more of 3G, 4G, 5G, 6G, another generation communication system, 802.11, millimeter waves, FD-MIMO, massive MIMO, MU-MIMO, cooperative MIMO, another type of communication system, or one or more combinations thereof. Additionally, other wireless communication protocols may be utilized in conjunction with aspects described herein. For example, embodiments of the present technology may be used with one or more wireless communication protocols or standards, including, but not limited to, CDMA 1×Advanced, GPRS, Ev-DO, TDMA, GSM, WiMAX technology, LTE, LTE Advanced, other technologies and standards, or one or more combinations thereof. As such, one or more communications-between or among two or more of cell site 110, one or more of servers 116A-116C, satellite 120, one or more of user devices 102A-102B, one or more of out-of-band nodes 104A-104E, another network component, or one or more combinations thereof—may correspond to one or more of 3G, 4G, 5G, 6G, another generation communication system, 802.11, millimeter wave communication, FD-MIMO, massive MIMO, MU-MIMO, cooperative MIMO, another type of communication protocol, one or more wireless communication protocols or standards (e.g., CDMA 1×Advanced, GPRS, Ev-DO, TDMA, GSM, WiMAX technology, LTE, LTE Advanced, other technologies and standards), or one or more combinations thereof. As one example, the one or more of the servers 116A-116C may transmit the encoded data or the operational instructions via one or more of 3G, 4G, 5G, 6G, another generation communication system, 802.11, millimeter wave communication, FD-MIMO, massive MIMO, MU-MIMO, cooperative MIMO, another type of communication protocol, one or more wireless communication protocols or standards (e.g., CDMA 1×Advanced, GPRS, Ev-DO, TDMA, GSM, WiMAX technology, LTE, LTE Advanced, other technologies and standards), or one or more combinations thereof.

In embodiments, one or more cell sites 110 can provide the one or more wireless communication services via network 108, the network 108 comprising one or more telecommunication networks, or a portion thereof. A telecommunication network might include an array of devices or components (e.g., one or more cell sites 110). The network 108 can include multiple networks, and the network can be a network of networks. In embodiments, the network 108 is a core network, such as an evolved packet core, which may include at least one MME, at least one serving gateway, and at least one Packet Data Network gateway. The MME may manage non-access stratum (e.g., control plane) functions such as mobility, authentication, and bearer management for other devices associated with the evolved packet core. In an embodiment, the network 108 comprises at least two core networks associated with a legacy LTE network and a 5G network. The at least two core networks may each operate one or more public land mobile networks, which may operate in each of the at least two core networks (e.g., one public land mobile network operates in each of an evolved packet core and a 5G core network). In embodiments, different core networks may be provided for different types of services, for different types of customers, for different types of traffic, to provide different levels of Quality of Service, or one or more combinations thereof. The network 108 can comprise any communication network providing voice, message, or data service(s), such as, for example, a 1× circuit voice, a 3G network (e.g., CDMA, CDMA2000, WCDMA, GSM, UMTS), a 4G network (WiMAX, LTE, HSDPA), a 5G network, a 6G network, another generation network, or one or more combinations thereof.

Components of the network 108, such as terminals, links, and nodes (as well as other components), can provide connectivity in various implementations. For example, components of the network 108 may include core network nodes, relay devices, integrated access and backhaul nodes, macro eNBs, small cell eNBs, gNBs, relay cell sites, satellites, other network components, or a combination thereof. The network 108 may interface with one or more cell sites through one or more wired or wireless backhauls. As such, the one or more cell sites 110 may communicate to the user device 102 and the wearables 120, 130, 132, 134, 136 via the network 108 or directly. Furthermore, user devices can utilize the network 108 to communicate with other devices (e.g., a user device(s), a server(s), etc.) through the one or more cell sites 110.

The one or more cell sites 110 may include one or more cells, band pass filters, radios, antennas, antenna arrays, power amplifiers, transmitters/receivers, digital signal processors, control electronics, GPS equipment, and the like. In some aspects, the cell site 110 may comprise one or more macro cells (providing wireless coverage for users within a large geographic area). For example, macro cells may correspond to a coverage area having a radius of approximately 1-15 miles or more, the radius measured at ground level and extending outward from an antenna at the cell site. In some aspects, cell site 110 may comprise, or be in communication with, one or more small cells (providing wireless coverage for users within a small geographic area). For example, a small cell may correspond to a coverage area having a radius of approximately less than three miles, the radius measured at ground level and extending outward from an antenna at the cell site. In embodiments, cell site 110 is in communication with a plurality of in-door small cells. In some embodiments, one or more of the out-of-band nodes 104A-104E are in-door small cells located within building 106.

Furthermore, the one or more of out-of-band nodes 104A-104E (e.g., the one or more small cells) may support out-of-band antenna communications via out-of-band signals (e.g., one or more ultrasonic frequencies (e.g., 20 kHz or higher), frequencies other than frequencies corresponding to 5G, 4G, etc. (e.g., frequencies other than 24-54 GHz, frequencies other than 600-900 MHz), frequencies other than Wi-Fi frequencies (e.g., frequencies other than 900 MHz, 2.4 GHz, 3.6 GHz, 4.9 GHz, 5 GHz, 5.9 GHz, 6 GHz and 60 GHz), frequencies other than extremely high frequencies (e.g., from 30 GHz to 300 GHz also known as the millimeter band)). Further, in some embodiments, one or more of the out-of-band nodes 104A-104E may have also an Ethernet cable backhaul. In some embodiments, the out-of-band nodes 104A-104E may have the capability of both transmitting out-of-band signaling and transferring data to multiple user devices during a single point in time via a plurality of antennas (e.g. via a multi-user MIMO antenna system).

Database 114 may include stored data received from one or more of user devices 102A-102B, out-of-band nodes 104A-104E, cell site 110, servers 116A-116C, satellite 120, another network component, or one or more combinations thereof. In some embodiments, database 114 is a centralized database including a single server. In some embodiments, database 114 is a distributed database having multiple locations that are in communication via the network 108. In some embodiments, the database 114 includes a hierarchical database (e.g., organized in a tree-like structure having parent-child relationships between data elements). For example, an indication-that the first user device 102A has received an out-of-band signal (e.g., from out-of-band node 104) having a first set of encoded data—may be stored in the hierarchical database 114 as having a child relationship to data elements corresponding to the first set of encoded data stored within database 114. As another example, user device 102A or 102B may transmit a user device identifier corresponding to the user device, cache information corresponding to an application downloaded onto the respective user device, or performance diagnostics information (e.g., relating to the application or a particular telecommunication service), over the network 108 based on the triggered user device action in response to receiving the encoded data in the out-of-band signal, wherein the user device identifier, cache information, and performance diagnostic information are stored in the hierarchical database 114 as having a child relationship to the data elements corresponding to the first set of encoded data. In yet another example, operational instructions—generated by one or more of the servers 116A-116C based on the first user device 102A receiving an out-of-band signal (e.g., from out-of-band node 104) having a first set of encoded data—may be stored in the hierarchical database 114 as having a child relationship to data elements corresponding to the first set of encoded data stored within database 114. In some embodiments, those operational instructions may be based on one or more of the user device identifier, cache information, performance diagnostic information, another type of user-device-provided information in response to triggering the user device action, or one or more combinations thereof, wherein those operational instructions are stored within the hierarchical database 114 as having a child relationship to the user-device-provided information.

In some embodiments, the database 114 is a network database (e.g., using a network model to represent the stored data), an object-oriented database (e.g., which defines objects by class and allowing object retrieval based on attributes and relationships), an in-memory database, a spatial database, a blockchain database, a relational database (e.g., Google Cloud SQL), non-relational databases having a flexible schema design with horizontal scalability for large volumes of unstructured or semi-structured data (e.g., MongoDB), a key-value store (e.g., Redis), a document database (e.g., CouchDB), a columnar database (e.g., Apache Cassandra, Google BigQuery), a graph database (e.g., Neo4j), a time-series database (e.g., InfluxDB), another type of database, or one or more combinations thereof. In embodiments, one or more of user devices 102A-102B, out-of-band nodes 104A-104E, cell site 110, servers 116A-116C, satellite 120, another network component, or one or more combinations thereof, may access, organize, or query the database 114.

The database 114 can store a plurality of data elements corresponding to the communications related to the user device 102A or 102B receiving the out-of-band signal, and the database 114 can be used for generating encoded data (e.g., generated by one or more of servers 116A-116C) for transmissions via the out-of-band signal, for generating additional operational instructions (e.g., generated by one or more of servers 116A-116C) for the user device 102A or 102B based on the respective user device receiving the out-of-band signal, as well as out-of-band transmission adjustments (e.g., an adjustment to the frequency of the out-of-band transmission, an adjustment to the transmission power of the out-of-band transmission, an adjustment to the periodicity of the out-of-band transmissions, an adjustment to the transmission pattern of the out-of-band transmission). In addition, the database 114 can be used for generating decryption keys for the user device 102A or 102B to use for decrypting the encoded data received from the out-of-band transmission. In embodiments, one or more of the servers 116A-116C can also generate the out-of-band transmission adjustments and the decryption keys.

In embodiments, one or more of the servers 116A-116C may be a web server (e.g., having one or more server nodes for balancing load and redundancy), such that the user device action triggered by the encoded data within an out-of-band signal includes the user device automatically launching a webpage hosted by the web server. In embodiments, one or more of the servers 116A-116C may be an application server (e.g., providing database connectivity, transactional management services, messaging services, other communication services), such that the user device action triggered by the encoded data within an out-of-band signal includes the user device automatically launching an application (or in some embodiments, automatically launching the application and initiating a communication service, for example) provided by the application server. In embodiments, one or more of the servers 116A-116C may be a database server (e.g., providing access to database 114, permitting data transmission to or retrieval from database 114), such that the user device action triggered by the encoded data within an out-of-band signal includes the user device automatically initiating communication with the database server (e.g., an SQL server, MySQL). In embodiments, one or more of the servers 116A-116C may be a mail server (e.g., having one or more transfer agents, having one or more mail delivery or retrieval agents), such that the user device action triggered by the encoded data within an out-of-band signal includes the user device automatically transmitting or receiving a message (e.g., an email) from (or to) the mail server). In some embodiments, one or more of the servers 116A-116C may be a proxy server (e.g., providing load balancing, access control, filtering, etc., between or among servers 116A-116C), such that the proxy server can manage user device communications with another server. For example, the proxy server may determine user device priorities for access to the other server for a plurality of user devices upon a threshold number of the plurality of user devices each receiving an out-of-band signal within a threshold time range.

In embodiments, servers 116A-116C may include one or more processors, memory, a data store (e.g., a hardware drive, a solid-state drive), a network interface for transmitting or receiving communications over network 108, another server component, or one or more combinations thereof. In embodiments, one or more of the servers 116A-116C may include a network switch, a router, a load balancer, a firewall, another type of network equipment, or one or more combinations thereof. In embodiments, one or more of the servers 116A-116C may include a runtime environment (e.g., for execution of an application in which one of the user devices 102A-102B may automatically launch upon receiving encoded data within an out-of-band signal), a middleware component (e.g., to facilitate a messaging service via the application automatically launched by the user device 102A or 102B), a web-based interface, a command-line tool, another software component, or one or more combinations thereof.

In some embodiments, servers 116A-116C may have a central architecture (e.g., each server located within a threshold distance of the other servers or each located within a particular area) or a distributed architecture (e.g., each server being in a different location and connected via network 108 or a portion thereof). In some embodiments, servers 116A-116C may have a client-server architecture, wherein at least one of the servers responds to requests from another server, a peer-to-peer architecture wherein a node of each of the servers 116A-116C share resources or services, a three-tier architecture including a presentation layer, application layer, and data layer, a microservices architecture, a clustered architecture, a grid architecture, another type of architecture, or one or more combinations thereof. For example, in some embodiments, upon user device 102A or 102B receiving the encoded data via the out-of-band signal, the respective user device can launch an application provided by application layer 116A and presentation layer 116B. In response to the respective user device launching the application, that user device may transmit information over the network 108 (e.g., a user device identifier, an identifier received within the encoded data), and data layer 116C may transmit particular operational instructions to that user device (e.g., operational instructions for an update of the application, an update of a telecommunication service provided by a telecommunication provider hosting the application servers, an upgrade to the telecommunication service, an event admission ticket, an offer for a discount based on the location of the user device with respect to one of the out-of-band nodes 104A-104E).

In some embodiments, one or more of servers 116A-116C can generate one or more decryption keys for the user device 102A or 102B to decrypt the encoded data within the out-of-band signal. For example, one or more of servers 116A-116C may be a key management server that implements one or more algorithms to generate the one or more decryption keys (e.g., via a random number generator, a key derivation function that uses cryptographic algorithms (e.g., key-based key derivation functions, password-based key derivation functions), other types of key generation functions, or one or more combinations thereof). In some embodiments, one or more of the servers 116A-116C is a secure sockets layer/transport layer security server (e.g., that generates decryption keys using asymmetric cryptography or symmetric cryptography), a hardware security module, a cryptocurrency wallet server, a digital rights management server, a certificate authorizing server, another type of decryption key generating server, or one or more combinations thereof. In some embodiments, one or more of the servers 116A-116C can provide a first decryption key to user device 102A for the user device 102A to decrypt a first set of encoded data received from an out-of-band signal transmitted by out-of-band node 104A. In some embodiments, one or more of the servers 116A-116C can provide a second decryption key to user device 102B for the user device 102B to decrypt a second set of encoded data received from an out-of-band signal transmitted by out-of-band node 104B. In some embodiments, one or more of the servers 116A-116C can provide a third decryption key to user device 102A for the user device 102A to decrypt a third set of encoded data received from an out-of-band signal transmitted by out-of-band node 104C.

In embodiments, satellite 120 may communicate with the cell site 110, user devices 102A-102B, out-of-band nodes 104A-104E, database 114, servers 116A-116C, another network component, or one or more combinations thereof. In some embodiments, satellite 120 may include a space vehicle or communication satellite. Satellite 120 may be any suitable type of communication satellite configured to relay communications between different devices within environment 100. Satellite 120 may be or include a space satellite, a balloon, a dirigible, an airplane, a drone, an unmanned aerial vehicle, another type of satellite, or one or more combinations thereof. In some examples, the satellite 120 may be in a geosynchronous or geostationary earth orbit, a low earth orbit, a medium earth orbit, another type of orbit, or one or more combinations thereof. In some embodiments, satellite 120 may be a multi-beam satellite configured to provide service for multiple service beam coverage areas in a predefined geographical service area. The satellite 120 may be any distance away from the surface of the earth. In one non-limiting example, satellite 120 may correspond to a geosynchronous earth orbiting satellite or may have a satellite operating configuration corresponding to multiple service beam coverage areas in a predefined geographical service area.

In some embodiments, the one or more servers 116A-116C can receive information from or transmit information (e.g., encoded data, operational instructions) to one or more of the user devices 102A-102B or one or more of the out-of-band nodes 104A-104E via satellite 120 (e.g., the space satellite, balloon, dirigible, airplane, drone, unmanned aerial vehicle, multi-beam satellite, another type of satellite, or one or more combinations thereof). For example, this information transmitted or received via the satellite 120 may correspond to a free space optical link, a microwave link, electromagnetic wave signals via millimeter wave signals, optical signals via a laser, another type of communication link, a wireless common public radio interface protocol, a dedicated wireless front haul protocol developed for high-altitude-to-high-altitude, another protocol, or one or more combinations thereof. In some embodiments, the satellite 120 can demodulate received information and transmit that demodulated information, decode the encoded data transmitted from the user devices 102A-102B or decode the encoded data for the user devices 102A-102B, re-encoding the encoded data transmitted by the one or more servers 116A-116C, re-encoding the decrypted encoded data (decrypted by the user device 102A or 102B) and transmitted by the user device 102A or 102B, modulate the encoded data once transmitted, perform another type of satellite or regenerative transponder function on data transmitted (e.g., by the user device 102A), or one or more combinations thereof.

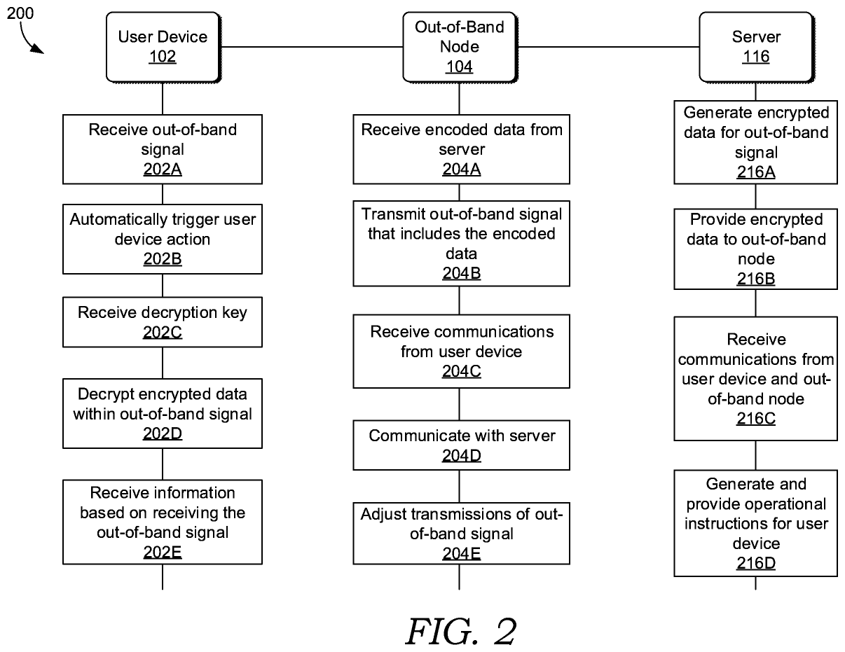

FIG. 2 illustrates example operational environment 200 comprising user device 102, out-of-band node 104, and server 116. In embodiments, at 202A, the user device 102 can receive an out-of-band signal transmitted by the out-of-band node 104 (e.g., based on a location of the user device 102, based on the user device 102 being within a threshold distance from the out-of-band node 104). In some embodiments, the user device 102 can receive a plurality of out-of-band signals from the out-of-band node 104, the plurality of out-of-band signals including a first out-of-band signal including a first set of encoded data and a second out-of-band signal including a second set of encoded data that triggers a different user device action than the first set of encoded data. In some embodiments, the user device 102 prioritizes the first set of encoded data of the second set of encoded data based on the model of the user device 102, the version of the user device 102, the area code of the user device 102, another type of user device identifier, or one or more combinations thereof.

The out-of-band signal can include encoded data in which, at 202B, automatically triggers a user device action upon receipt of the out-of-band signal by the user device 102. In some embodiments, the user device action may include automatically updating a particular software program (e.g., based on a version identifier associated with the particular software program, based on a particular version of the user device 102), automatically launching an application downloaded on the user device 102, downloading an application onto the user device 102, automatically opening a webpage for display onto a graphical user interface of the user device 102, automatically transmitting a particular user device identifier over the network, automatically trigger haptics of the user device 102, automatically transmitting performance diagnostics information or other information over the network, automatically emitting light from one or more light emitting components of the user device 102, automatically displaying one or more of graphics onto a graphical user interface of the user device 102, automatically displaying one or more prompts onto a graphical user interface of the user device 102, automatically providing one or more audio prompts, automatically providing one or more alerts or push-notifications, automatically providing an in-app notification, another type of user device action, or one or more combinations thereof.

At 202C, the user device 102 can receive a decryption key (e.g., from the server 116, which may be a trusted server) for decrypting the encoded data (within the out-of-band signal) at 202D. For example, the user device may receive a symmetric encryption key (e.g., corresponding to an encryption standard), an asymmetric encryption key corresponding to a private key, a session key, another type of encryption key, or one or more combinations thereof. In some embodiments, the user device 102 implements key retrieval, wherein the decryption key was previously stored by the user device 102. In some embodiments, the user device 102 verifies the authenticity of the decryption key or the integrity of the decryption key. Based on decrypting the encoded data, one or more processors of the user device 102 (e.g., one or more microprocessors, one or more CPUs, a digital signal processor, one or more cores, a host processor, a controller, a chip, a microchip, one or more circuits, a logic unit, an integrated circuit (IC), an application-specific IC (ASIC), a multi-purpose or specific processor or controller, another type of processor, or one or more combinations thereof) can process the decrypted data. In some embodiments, the user device action triggered by the encoded data within the out-of-band signal may include decrypting the encoded data for user device analysis and automatically launching an application or webpage based on a preamble corresponding to the encoded data message.

At 202E, the user device 102 can receive information (e.g., operational instructions) over the network based on receiving the out-of-band signal from the out-of-band node 104. For example, the user device 102 may receive (e.g., from server 116) a first set of operational instructions that cause the user device to display an emergency notification (e.g., via the launched application through a push-notification) and to provide haptic feedback or an audio notification. In some embodiments, the user device 102 may receive an updated telecommunications service provided by a telecommunications service provider based on user device identifying information associated with the particular application that was launched. In some embodiments, the updated telecommunications service may be based on cache information and performance diagnostics information identified by the user device 102.

At 204A, the out-of-band node 104 can receive encoded data from server 116. In some embodiments, the out-of-band node 104 can also receive a decryption key from the server 116. In some embodiments, the out-of-band node 104 can receive updated encoded data from server 116 after a threshold period of time. In some embodiments, the out-of-band node 104 can receive multiple sets of encoded data from server 116, wherein the server 116 instructs the out-of-band node to transmit a first set of encoded data at a particular out-of-band frequency, at a particular transmission power (e.g., based on transmitter characteristics of the out-of-band node, based on a location of the out-of-band node within an indoor environment or outdoor environment, based on the positioning of the out-of-band node relative to interfering objections (e.g., a wall or a corner of a room, an adjacent street sign, an aisle within a store)), at a particular angle, at a particular periodicity, another type of out-of-band transmission instruction, or one or more combinations thereof.

At 204B, the out-of-band node can transmit one or more out-of-band signals (e.g., having one or more frequencies), the out-of-band signal including the encoded data. In some embodiments, the out-of-band node can transmit the out-of-band signal (e.g., an ultrasonic signal) via a particular transmission pattern. In some embodiments, the out-of-band signal is transmitted via a continuous wave pattern, via a pulse-echo pattern (e.g., wherein the out-of-band node 104 measures a return time of the out-of-band), via an amplitude modulation pattern (e.g., varying the amplitude of the out-of-band signal), via a frequency modulation pattern (e.g., varying the frequency of the out-of-band signal), via a beamforming pattern (e.g., a directional transmission of the out-of-band signal), via a sweep frequency pattern (e.g., continuously sweeping the frequency of the out-of-band signal over time), another type of out-of-band transmission pattern, or one or more combinations thereof.

At 204C, the out-of-band node 104 can receive communications from the user device 102 and at 204D, the out-of-band node 104 can further communicate with the server 116 (e.g., after transmitting one or more out-of-band signals, after receiving an indication that the user device 102 has received the out-of-band signal). In some embodiments, the out-of-band node 104 can receive, from the user device 102, a signal strength corresponding to the out-of-band signal transmitted by the out-of-band node. For example, the out-of-band node 104 can receive an echo amplitude from the out-of-band signal that was detected by the user device 102, a signal-to-noise ratio detected by the user device 102, a signal strength indicator detected by the user device 102, a range of signal strengths detected by the user device 102, a distribution of signal strengths detected by the user device 102, other types of user device measurements associated with the out-of-band signal, or one or more combinations thereof. In some embodiments, the out-of-band node 104 can transmit these received measurements to the server 116. In some embodiments, the out-of-band node 104 can receive instructions from the server 116 to adjust the transmissions of the out-of-band nodes (e.g., to adjust to a different out-of-band frequency, to adjust to a different transmission power, to adjust to a different transmission pattern, etc.). In embodiments, at 204E, the out-of-band node 104 can adjust these transmissions based on these instructions from the server 116.

At 216A, the server 116 can generate the encrypted data for the out-of-band signal (e.g., via a random number generator, a key derivation function that uses cryptographic algorithms (e.g., key-based key derivation functions, password-based key derivation functions), other types of key generation functions, or one or more combinations thereof). For example, in some embodiments, the server 116 can generate a first set of encoded data using a key-based key derivation function and a second set of encoded data using a password-based key derivation function. Further, at 216B, the server 116 can transmit the encoded data to the out-of-band node 104. For example, in some embodiments, a cell site or satellite can re-encode the encoded data transmitted by the server 116 and transmit the re-encoded data to the out-of-band node 104.

At 216C, the server 116 can receive (or transmit) communications from the user device 102 and the out-of-band node 104. For example, the server 116 can receive, over a network from and from the user device 102 or the out-of-band node 104, an indication that the user device 102 has received the out-of-band signal having a first set of encoded data from the out-of-band node 104. In some embodiments, at 216D, the server 116 can provide the user device 102 with additional operational instructions generated by the server 116 based on the user device 102 receiving the out-of-band signal. For example, in some embodiments, the additional operational instructions may include causing the user device 102 to provide a push-notification via a particular application downloaded onto the user device. In some embodiments, the push-notification (or another type of notification) may include one or more offers or discounts for a particular product or service. In some embodiments, the notification may include an emergency notification and a selectable icon to confirm receipt of the emergency notification.

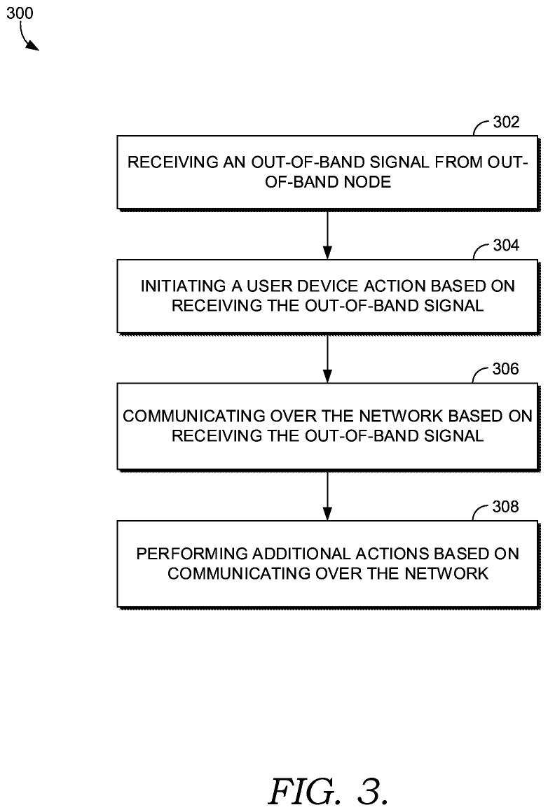

FIG. 3 depicts example flow diagram 300 for a user device. At 302, the user device can receive an out-of-band signal from an out-of-band node. For example, the out-of-band signal can include encoded data that triggers an action via the user device upon receipt by the user device, wherein the user device receives the out-of-band signal based on the user device being within a threshold distance of the out-of-band node. At 304, the user device can trigger the action based on the encoded data without utilizing a telecommunication service provided by a telecommunication service provider. At 306, the user device can receive information over a network based on triggering the action (e.g., receive operational instructions from a server). In some embodiments, triggering the action may include launching a webpage or an application downloaded on the user device, the application corresponding to a telecommunications service provider.

In some embodiments, the user device can also transmit, over the network and based on triggering the action, a user device identifier corresponding to the user device over the network. The user device may also transmit, over the network and based on triggering the action, cache information corresponding to the application and performance diagnostics information. In addition, the user device may also receive the information over the network to update a telecommunications service provided by the telecommunications service provider based on transmitting the user device identifier, the cache information, and the performance diagnostics information.

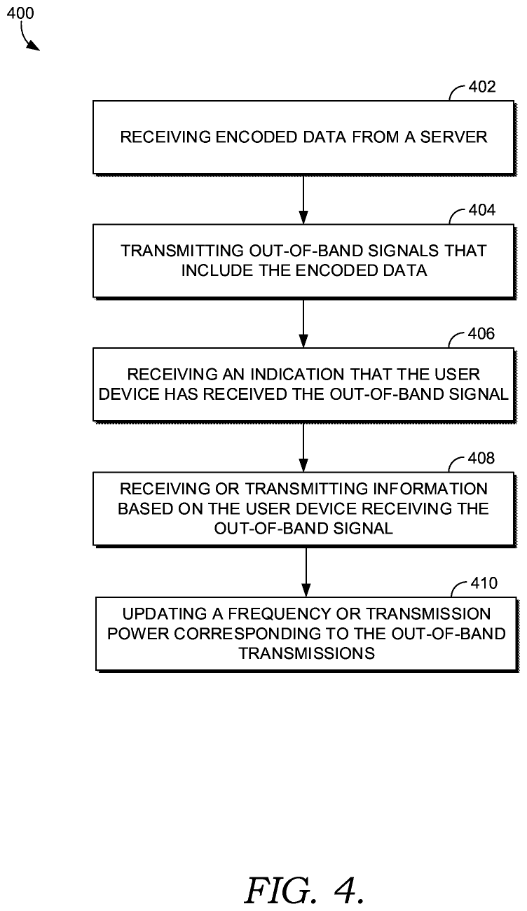

FIG. 4 depicts example flow diagram 400 for an out-of-band node. The out-of-band node can be configured to wirelessly transmit out-of-band signals (e.g., ultrasonic signals) to a user device that is located within a threshold distance of the out-of-band node. The out-of-band node may include one or more processors that are configured to perform operations. At 402, the out-of-band node may transmit an out-of-band signal that includes encoded data for receipt by the user device within the threshold distance of the out-of-band node, wherein upon receipt by the user device, the encoded data triggers the user device to initiate an action. For example, in embodiments, the encoded data triggers the user device to initiate the action of updating a software program based on a version identifier corresponding to the software program.

In some embodiments, a plurality of out-of-band nodes each positioned (e.g., in an indoor or outdoor environment) within a second threshold distance from at least one other out-of-band node of the plurality of out-of-band nodes. For example, the plurality of out-of-band nodes can each be configured to wirelessly transmit one or more out-of-band signals (e.g., at one or more particular frequencies, at one or more particular transmission patterns, etc.), to a user device when the user device is within the threshold distance of a respective out-of-band node of the plurality of out-of-band nodes, each out-of-band signal including a set of encoded data.

In some embodiments, the out-of-band node can transmit additional out-of-band signals (e.g., a second out-of-band signal, a third out-of-band signal, etc.) that includes additional sets of encoded data (e.g., a second out-of-band signal including a second set of encoded data, a third out-of-band signal including a third set of encoded data, a fourth out-of-band signal including the second set of encoded data (e.g., wherein the second and fourth out-of-band signals have different frequencies or different transmission patterns)) for receipt by the user device within the threshold distance of the out-of-band node. In some embodiments, the second set of encoded data triggers the user device to initiate a second action that is different from the action triggered by the first set of encoded data.

At 404, the out-of-band node can receive an indication that the user device has received the out-of-band signal, and at 406, the out-of-band node can transmit information associated with the user device receiving the out-of-band signal (e.g., transmit the information to a server). For example, in some embodiments, the out-of-band node can receive, from the user device, a signal strength corresponding to the out-of-band signal transmitted by the out-of-band node. In addition, the out-of-band node can determine a location of the user device at receipt of the out-of-band signal based on the indication that the user device has received the out-of-band signal. In addition, the out-of-band node can adjust the signal strength for transmitting the out-of-band signals based on the location of the user device and the signal strength. In addition, the out-of-band node can determine an anticipated user device traffic volume within a radius of the out-of-band node, wherein the radius is a greater distance from the out-of-band node than the threshold distance. Additionally, the out-of-band node can adjust a periodicity for transmitting the out-of-band signals based on the anticipated user device traffic volume.

In embodiments wherein the plurality of out-of-band nodes are each positioned within the second threshold distance from at least one other out-of-band node of the plurality of out-of-band nodes, a second out-of-band node of the plurality of out-of-band nodes can receive an indication that the user device has received the out-of-band signal transmitted by the second out-of-band node. In embodiments, based on receiving the indication, the second out-of-band node may transmit information (e.g., the information including a distance between the second out-of-band node and the user device, a version identifier of a software program downloaded on the user device, a signal strength detected by the user device and transmitted to the second out-of-band node, an echo amplitude detected by the user device and transmitted to the second out-of-band node) to the server.

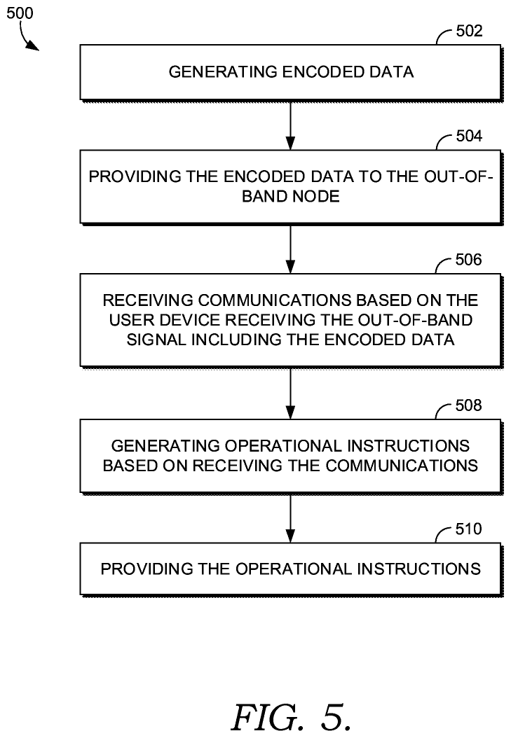

FIG. 5 depicts example flow diagram 500 for a server. At 502, the server can generate encoded data, or various sets of encoded data, to transmit to one or more out-of-band nodes, the wherein the encoded data triggers one or more user devices to initiate a first user device action. For example, the server can use symmetric encryption (e.g., using an advanced encryption standard algorithm, a triple data encryption standard algorithm), asymmetric encryption (e.g., using elliptic curve cryptography, a Diffie-Hellman algorithm), hybrid encryption, hashing and message authentication codes, another type of encryption tool, or one or more combinations thereof. At 504, the server can provide one or more out-of-band nodes one or more sets of encoded data.

At 506, the server can receive, over a network from a first user device, an indication that the first user device has received the out-of-band signal having a first set of encoded data. For example, the server may receive the indication from the user device or the out-of-band node. As another example, the server may receive a signal strength of the out-of-band signal that the first user device received from a first out-of-band node transmitting the out-of-band signal. In some embodiments, the server may receive, over the network from a plurality of user devices, an indication that each of a plurality of user devices has received the out-of-band signal from at least one of a plurality of out-of-band nodes. In some embodiments, the server can provide, via an application downloaded onto the first user device, listening instructions to the first user device for receiving the out-of-band signal. In some embodiments, the server can adjust the listening instructions (e.g., based on feedback provided by the user device related to the signal strength of the out-of-band signal).

At 508, the server generates a first set of operational instructions to transmit to one or more user devices, the first set of operational instructions to be transmitted based on the one or more user devices receiving the out-of-band signal having a first set of encoded data that triggers the one or more user devices to initiate a first action. In some embodiments, the server may generate a second set of operational instructions to transmit to the one or more user devices, the second set of operational instructions to be transmitted based on the one or more user devices receiving a second out-of-band signal having a second set of encoded data that triggers the one or more user devices to initiate a second action that is different from the first action, the out-of-band signal and the second out-of-band signal each having different frequency bands. In some embodiments, the server transmits the first set of operational instructions to a plurality of out-of-band nodes, each of the plurality of out-of-band nodes located within a threshold distance from at least one other of the plurality of out-of-band nodes.

At 510, the server provides a user device the operational instructions. In some embodiments, a first set of operational instructions cause the first user device to launch a webpage corresponding to an event associated with a time that the first user device received the out-of-band signal and a location in which the first user device received the out-of-band signal. In some embodiments, the first set of operational instructions cause the first user device to display an emergency notification based on a location of the first user device upon receiving the out-of-band signal. In some embodiments, the server can provide a second user device, over the network, a second set of operational instructions based on the server receiving, over the network from the second user device, an indication that the second user device has received the second out-of-band signal having the second set of encoded data.

In some embodiments, the server can determine that the signal strength of the out-of-band signal is below a threshold based on the server receiving the signal strength from a first out-of-band node transmitting the out-of-band signal. In other embodiments, the server can determine that the signal strength is below the threshold based on the server receiving the signal strength from the user device. In some embodiments, the server can then instruct the first out-of-band node to increase a transmission power corresponding to the out-of-band signal or adjust the frequency or periodicity of the out-of-band signal. In some embodiments, the server may also determine that a user device traffic volume (e.g., within a radius of a first out-of-band node transmitting the out-of-band signal) is above a threshold and instruct the first out-of-band node to increase a periodicity for transmitting the out-of-band signal.

### Example User Device

Having described the example embodiments discussed above of the presently disclosed technology, an example operating environment of an example user device (e.g., user device 102A of FIG. 1) is described below with respect to FIG. 6. User device 600 is but one example of a suitable computing environment and is not intended to suggest any particular limitation as to the scope of use or functionality of the technology disclosed. Neither should user device 600 be interpreted as having any dependency or requirement relating to any particular component illustrated, or a particular combination of the components illustrated in FIG. 6.

As illustrated in FIG. 6, example user device 600 includes a bus 602 that directly or indirectly couples the following devices: memory 604, one or more processors 606, one or more presentation components 608, one or more input/output (I/O) ports 610, one or more I/O components 612, a power supply 614, and one or more radios 616.

Bus 602 represents what may be one or more busses (such as an address bus, data bus, or combination thereof). Although the various blocks of FIG. 6 are shown with lines for the sake of clarity, in reality, these blocks represent logical, not necessarily actual, components. For example, one may consider a presentation component, such as a display device, to be an I/O component. Also, processors have memory. Accordingly, FIG. 6 is merely illustrative of an exemplary user device that can be used in connection with one or more embodiments of the technology disclosed herein.

User device 600 can include a variety of computer-readable media. Computer-readable media can be any available media that can be accessed by user device 600 and may include both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by user device 600. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. One or more combinations of any of the above should also be included within the scope of computer-readable media.

Memory 604 includes computer storage media in the form of volatile and/or nonvolatile memory. The memory 604 may be removable, non-removable, or a combination thereof. Example hardware devices of memory 604 may include solid-state memory, hard drives, optical-disc drives, other hardware, or one or more combinations thereof. As indicated above, the computer storage media of the memory 604 may include RAM, Dynamic RAM, ROM, EEPROM, flash memory or other memory technology, CD-ROM, a cache memory, DVDs or other optical disk storage, magnetic cassettes, magnetic tape, magnetic disk storage or other magnetic storage devices, a short-term memory unit, a long-term memory unit, any other medium which can be used to store the desired information and which can be accessed by user device 600, or one or more combinations thereof.

The one or more processors 606 of user device 600 can read data from various entities, such as the memory 604 or the I/O component(s) 612. The one or more processors 606 may include, for example, one or more microprocessors, one or more CPUs, a digital signal processor, one or more cores, a host processor, a controller, a chip, a microchip, one or more circuits, a logic unit, an integrated circuit (IC), an application-specific IC (ASIC), any other suitable multi-purpose or specific processor or controller, or one or more combinations thereof. In addition, the one or more processors 606 can execute instructions (e.g., operational instructions received by the one or more servers 116A-116C of FIG. 1 or user device actions triggered by encoded data from the out-of-band signals), for example, of an operating system of the user device 600 or of one or more suitable applications. Further, the one or more processors 606 can apply a decryption key to the encoded data received from the out-of-band signals.

The one or more presentation components 608 can present data indications via user device 600, another user device, or a combination thereof. Example presentation components 608 may include a display device, speaker, printing component, vibrating component, another type of presentation component, or one or more combinations thereof. In some embodiments, the one or more presentation components 608 may comprise one or more applications or services on a user device, across a plurality of user devices, or in the cloud. The one or more presentation components 608 can generate user interface features based on receiving the encoded data through the out-of-band signal, the interface features including one or more of graphics, buttons, sliders, menus, lists, prompts, charts, audio prompts, alerts, vibrations, pop-ups, notification-bar or status-bar items, in-app notifications, other user interface features, or one or more combinations thereof.

The one or more I/O ports 610 allow user device 600 to be logically coupled to other devices, including the one or more I/O components 612, some of which may be built in. Example I/O components 612 can include a microphone, joystick, game pad, satellite dish, scanner, printer, wireless device, and the like. The one or more I/O components 612 may, for example, provide a natural user interface (NUI) that processes air gestures, voice, or other physiological inputs generated by a user. In some instances, the inputs the user generates may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with the one or more presentation components 608 on the user device 600. In some embodiments, the user device 600 may be equipped with one or more imaging devices, such as one or more depth cameras, one or more stereoscopic cameras, one or more infrared cameras, one or more RGB cameras, another type of imaging device, or one or more combinations thereof, (e.g., for gesture detection and recognition). Additionally, the user device 600 may, additionally or alternatively, be equipped with accelerometers or gyroscopes that enable detection of motion. In some embodiments, the output of the accelerometers or gyroscopes may be provided to the one or more presentation components 608 of the user device 600 to render immersive augmented reality or virtual reality.

The power supply 614 of user device 600 may be implemented as one or more batteries or another power source for providing power to components of the user device 600. In embodiments, the power supply 614 can include an external power supply, such as an AC adapter or a powered docking cradle that supplements or recharges the one or more batteries. In aspects, the external power supply can override one or more batteries or another type of power source located within the user device 600.

Some embodiments of user device 600 may include one or more radios 616 (or similar wireless communication components). The one or more radios 616 can transmit, receive, or both transmit and receive signals for wireless communications (e.g., out-of-band signals). In embodiments, the user device 600 may be a wireless terminal adapted to receive communications (e.g., out-of-band signals) and media over various wireless networks. User device 600 may communicate using the one or more radios 616 via one or more wireless protocols, such as code division multiple access (“CDMA”), global system for mobiles (“GSM”), time division multiple access (“TDMA”), another type of wireless protocol, or one or more combinations thereof. In embodiments, the wireless communications may include one or more short-range connections (e.g., a Wi-Fi® connection, a Bluetooth connection, a near-field communication connection), a long-range connection (e.g., CDMA, GPRS, GSM, TDMA, 602.16 protocols), or one or more combinations thereof. In some embodiments, the one or more radios 616 may facilitate communication via radio frequency signals, frames, blocks, transmission streams, packets, messages, data items, data, another type of wireless communication, or one or more combinations thereof. The one or more radios 616 may be capable of transmitting, receiving, or both transmitting and receiving wireless communications via mmWaves, out-of-band signals, FD-MIMO, massive MIMO, 3G, 4G, 5G, 6G, another type of Generation, 802.11 protocols and techniques, another type of wireless communication, or one or more combinations thereof.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software. For instance, various functions may be carried out by a processor executing instructions stored in memory. As such, other arrangements and elements (for example, machines, interfaces, functions, orders, and groupings of functions, and the like) can be used in addition to, or instead of, those shown.

Embodiments of the present disclosure have been described with the intent to be illustrative rather than restrictive. Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A system for transmitting out-of-band signals for a user device trigger, the system comprising:
an out-of-band node configured to wirelessly transmit the out-of-band signals to a user device within a threshold distance of the out-of-band node; and
one or more processors corresponding to the out-of-band node, the one or more processors configured to perform operations comprising:
transmitting an out-of-band signal that includes encoded data for receipt by the user device within the threshold distance of the out-of-band node, wherein upon receipt by the user device, the encoded data triggers the user device to initiate an action;
receiving an indication that the user device has received the out-of-band signal; and
transmitting information associated with the user device receiving the out-of-band signal.

2. The system of claim 1, wherein the system further comprises a plurality of out-of-band nodes each within a second threshold distance from at least one other out-of-band node of the plurality of out-of-band nodes, the plurality of out-of-band nodes including the out-of-band node, wherein each of the plurality of out-of-band nodes are configured to wirelessly transmit the out-of-band signal, including the encoded data, to the user device when the user device is within the threshold distance of a respective out-of-band node of the plurality of out-of-band nodes.

3. The system of claim 2, wherein a second out-of-band node of the plurality of out-of-band nodes receives an indication that the user device has received the out-of-band signal, and wherein the second out-of-band node transmits the information, including a distance between the second out-of-band node and the user device and a version identifier of a software program downloaded on the user device, to a server.

4. The system of claim 3, wherein the encoded data triggers the user device to initiate the action of updating the software program based on the version identifier.

5. The system of claim 1, wherein the out-of-band signal is an ultrasonic signal.

6. The system of claim 1, the operations further comprising:
transmitting a second out-of-band signal that includes a second set of encoded data for receipt by the user device within the threshold distance of the out-of-band node, wherein upon receipt by the user device, the second set of encoded data triggers the user device to initiate a second action that is different from the action.

7. The system of claim 1, the operations further comprising:
receiving, from the user device, a signal strength corresponding to the out-of-band signal transmitted by the out-of-band node;
determining a location of the user device at receipt of the out-of-band signal based on the indication that the user device has received the out-of-band signal; and
adjusting the signal strength for transmitting the out-of-band signals based on the location of the user device and the signal strength.

8. The system of claim 7, the operations further comprising:
determining an anticipated user device traffic volume within a radius of the out-of-band node, wherein the radius is a greater distance from the out-of-band node than the threshold distance; and
adjusting a periodicity for transmitting the out-of-band signals based on the anticipated user device traffic volume.

9. A method for triggering an action by a user device, the method comprising:
generating a first set of operational instructions to transmit to one or more user devices, the first set of operational instructions to be transmitted based on the one or more user devices receiving an out-of-band signal having a first set of encoded data that triggers the one or more user devices to initiate a first action;
receiving, over a network from a first user device of the one or more user devices, an indication that the first user device has received the out-of-band signal having the first set of encoded data; and
providing the first user device, over the network, the first set of operational instructions.

10. The method of claim 9, further comprising:
generating a second set of operational instructions to transmit to the one or more user devices, the second set of operational instructions to be transmitted based on the one or more user devices receiving a second out-of-band signal having a second set of encoded data that triggers the one or more user devices to initiate a second action that is different from the first action, the out-of-band signal and the second out-of-band signal each having different frequency bands;
receiving, over the network from a second user device of the one or more user devices, an indication that the second user device has received the second out-of-band signal having the second set of encoded data; and
providing the second user device, over the network, the second set of operational instructions.

11. The method of claim 9, wherein the first set of operational instructions cause the first user device to display an emergency notification based on a location of the first user device upon receiving the out-of-band signal.

12. The method of claim 9, further comprising:
receiving, over the network from the first user device, a signal strength of the out-of-band signal that the first user device received from a first out-of-band node transmitting the out-of-band signal;
determining the signal strength is below a threshold; and
instructing the first out-of-band node to increase a transmission power corresponding to the out-of-band signal.

13. The method of claim 9, further comprising:
determining a user device traffic volume within a radius of a first out-of-band node transmitting the out-of-band signal is above a threshold; and
instructing the first out-of-band node to increase a periodicity for transmitting the out-of-band signal based on the user device traffic volume being above the threshold.

14. The method of claim 9, further comprising:
providing, via an application downloaded onto the first user device, listening instructions to the first user device for receiving the out-of-band signal;
generating the first set of encoded data for a plurality of out-of-band nodes to transmit the out-of-band signal that includes the first set of encoded data; and
providing the first set of encoded data to the plurality of out-of-band nodes.

15. The method of claim 9, further comprising providing, via the application, a decryption key to the user device for decrypting the first set of encoded data, and wherein the indication that the first user device has received the out-of-band signal includes receiving the decrypted data.

16. The method of claim 9, wherein the first set of operational instructions cause the first user device to launch a webpage corresponding to an event associated with a time that the first user device received the out-of-band signal and a location in which the first user device received the out-of-band signal.

17. The method of claim 9, further comprising:
transmitting the first set of operational instructions to a plurality of out-of-band nodes, each of the plurality of out-of-band nodes located within a threshold distance from at least one other of the plurality of out-of-band nodes;
receiving, over the network from a plurality of user devices, an indication that each of the plurality of user devices has received the out-of-band signal from at least one of the plurality of out-of-band nodes;
providing each of the plurality of user devices, over the network, the first set of operational instructions;
determining a user device traffic volume for a location in which the plurality of out-of-band nodes are located; and
adjusting a frequency at which each of the plurality of out-of-band nodes are transmitting the out-of-band signal based on the user device traffic volume.

18. One or more non-transitory computer storage media having computer-executable instructions embodied thereon, that when executed by at least one processor, cause the at least one processor to perform a method for initiating a user device trigger based on receiving out-of-band signals, the method comprising:
receiving, via a user device, an out-of-band signal from an out-of-band node, the out-of-band signal including encoded data that triggers an action via the user device upon receipt by the user device, wherein the user device is within a threshold distance of the out-of-band node;
triggering, via the user device, the action based on the encoded data without utilizing a telecommunication service provided by a telecommunication service provider; and
receiving, via the user device, information over a network based on triggering the action.

19. The non-transitory computer-readable media of claim 18, wherein triggering the action includes launching an application downloaded on the user device, the application corresponding to a telecommunications service provider, and wherein the method further comprises:
transmitting, over the network and based on triggering the action, a user device identifier corresponding to the user device over the network;
transmitting, over the network and based on triggering the action, cache information corresponding to the application and performance diagnostics information; and
receiving the information over the network to update a telecommunications service provided by the telecommunications service provider based on transmitting the user device identifier, the cache information, and the performance diagnostics information.

20. The non-transitory computer-readable media of claim 18, wherein triggering the action includes launching an application downloaded on the user device, the application having access to one or more light emitting components of the user device, wherein the information received over the network includes timing and duration instructions for the user device to emit light from the one or more light emitting components, and wherein the method further comprises:
emitting, via the one or more light emitting components, light based on the timing and duration instructions received over the network.
